(19) United States
(12) Patent Application Publication
(10) Pub. No.: US 2001/0023464 A1
(43) Pub. Date: Sep. 20, 2001

(54) Time synchronization of units in a system

(76) Inventors: Bernhard Deck, Weilheim (DE); Hans-Peter Zueger, Hausen (CH)

Correspondence Address: BURNS DOANE SWECKER & MATHIS L L P, POST OFFICE BOX 1404, ALEXANDRIA, VA, 22313-1404, US

(21) Appl. No.: 09/805,922

(22) Filed: Mar. 15, 2001

(30) Foreign Application Priority Data
Mar. 17, 2000 (DE) 100 13 348.7

(51) Int. Cl. G06F 13/00; G06F 13/42

(52) U.S. Cl. 710/105; 710/100

(57) ABSTRACT

In a method for time synchronization of units (2) in a system (A) which has a timebase unit (1) which is connected via a deterministic communications network (3) to the units (2), the timebase unit (1) transmits protocol packets (P) via the deterministic communications network (3) to the units (2) at a defined time interval (t). These units (2) receive the protocol packets (P) and use the time interval (t) between the received protocol packets (P) for at least approximately identical clocking of the units (2). This results in high accuracy in the synchronization of system parts, using simple means.

The invention relates to a method for time synchronization of units in a system as claimed in the precharacterizing clause of patent claim 1, and to a system having a time-synchronization device as claimed in the precharacterizing clause of patent claim 8. The invention relates in particular to switchgear assemblies and automation systems in the high- and medium-voltage range.

Switchgear assemblies and automation systems such as this have a number of units or substations which are generally independent of one another and are often physically separated from one another. In order to ensure the functionality of the system, these units have to operate on the basis of the same timebase, that is to say they must have the same clock lengths and, in general, must also be synchronized to one another. This synchronization is carried out according to the prior art in that data packets are transmitted from a first unit to a second unit and back again via a communications network, and the delay times of these transmitted and returned data packets are determined. The first unit then uses the delay time which has been determined to calculate a system time. The delay times which have been determined, and thus the system times, vary, however, so that the units operate using different timebases. This is because communications networks operate with changing transmission rates and with different reaction times in the returning of the data packet. In consequence, not only are the individual units not synchronized to one another with the desired accuracy, but their internal clocks may also have different clock lengths to one another.

In order to avoid such synchronization errors, the unpublished German Patent Application No. 199 33 684.9 proposes the use of the GPS (Global Positioning System) for the field of differential protection systems for a high-voltage network. Each protection unit has a GPS receiver in order to receive GPS time directly from a GPS satellite. All the protection units admittedly have the same clock, and this allows accurate synchronization. However, a disadvantage is that each protection unit must be equipped with a GPS receiver, which increases the cost of the system. Furthermore, for space reasons, it is often impossible to provide each protection unit with such a receiver.

The object of the invention is therefore to provide a method and a system of the type mentioned initially which overcome the abovementioned disadvantages.

This object is achieved by a method for time synchronization of units in a system as claimed in claim 1, and by a system having a time-synchronization device as claimed in claim 8.

According to the invention, the system itself has a timebase unit which is connected via a deterministic communications network to units in the system. The timebase transmits protocol packets at a defined time interval to the units, which use this time interval for clocking.

The transmission of local time using the protocol packet allows the units to be synchronized to a common time value. This transmission is preferably carried out at very short time intervals, in particular at a time interval of 1 second, with the time intervals between the individual transmitted protocol packets preferably varying by not more than 1 μs.

The timebase unit preferably uses GPS time as the time and clock, which it receives by means of a GPS receiver.

Further advantageous embodiments are described in the dependent patent claims.

The subject matter of the invention will be described in more detail in the following text with reference to a preferred exemplary embodiment which is illustrated in the attached drawing, in which:

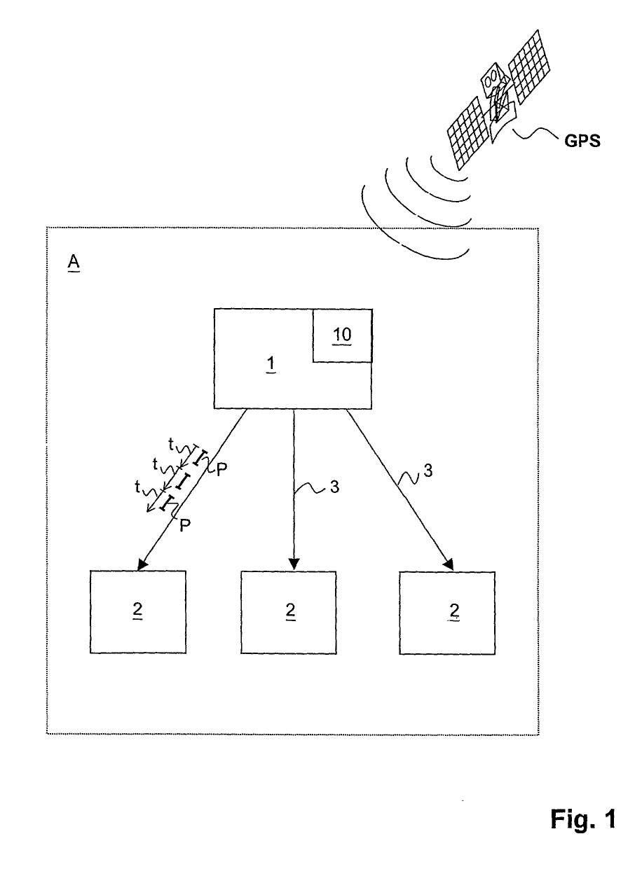

FIG. 1 shows a schematic illustration of a system according to the invention having a synchronization device.

FIG. 1 shows a system A according to the invention, schematically. This is preferably a switchgear assembly or automation system in the high- and medium-voltage range. The system A has a timebase unit 1 and a number of units 2, which are each connected to the timebase unit 1 via a communications network 3. The timebase unit 1 has means for the definition of a timebase. These means may be a clock integrated in the timebase unit 1, a receiver for a radio clock signal or, preferably, a GPS receiver 10. This GPS receiver 10 receives signals from a number of GPS satellites. The signal includes the time, and is transmitted as Universal Time (UT).

The communications network 3 is a deterministic communications network for transmission of protocol packets P, whose maximum discrepancy from the transmitted clock is in the microsecond range, at most. Suitable communications networks 3 for this purpose include, in particular, a fieldbus system, a DOL (Dedicated Optical Link) network, or else a wire-free network.

The timebase unit 1 transmits protocol packets P to the individual units 2 via the communications network 3 with a defined time interval t. The protocol packets in this case contain information about local time and, preferably, the date as well. IRIG-B protocol packets (IRIG=Interrange Instrumentation Group) are normally used.

The protocol packets are in this case transmitted at a time interval which varies by 1 μs at most. The time interval itself is 10^{-x} seconds, where x is a natural number including 0. The time interval is preferably exactly 1 second, that is to say x=0. The protocol packet itself preferably has a duration which is less than 10^{-x} seconds.

The units have means for receiving protocol packets. Furthermore, they have means for clocking their unit, so that the units are clocked at least approximately identically. The accuracy of the clocking is in this case a few ns.

The transmission of protocol packets at defined time intervals makes it possible for all the units in a system to operate on the same timebase. All the units operate with the same time unit, which is not subject to any drift varying with the unit. Transmission of the time information in the protocol packet also makes it possible for all the units to receive the same time value, provided the units have identical receivers. Furthermore, when using GPS receivers in the timebase units, a number of systems can be synchronized to one another, since, via the GPS, they are all operating on the same timebase. Since all the systems are operating synchronized to one another, sporadically occurring events in parts of the system can be compared with one another with accurate timing. A further advantage is that this provides the possibility for the sampling time of analogue signals in different systems to be selected to be precisely the same time.

1. A method for time synchronization of units (2) in a system (1) which has a timebase unit (1) which is connected via a deterministic communications network (3) to the units (2), with the timebase unit (1) transmitting protocol packets (P) via the deterministic communications network (3) to the units (2) at a defined time interval (t), which units (2) receive the protocol packets (2) and use the time interval (t) between the received protocol packets (P) for at least approximately identical clocking of the units (2).

2. The method as claimed in claim 1, characterized in that the protocol packets are transmitted at a time interval which varies by 1 μs at most.

3. The method as claimed in claim 1, characterized in that the protocol packets are transmitted at a time interval of 10^{-x} seconds, where x is a natural number including 0.

4. The method as claimed in claim 3, characterized in that x=0.

5. The method as claimed in claim 3, characterized in that protocols are transmitted with a length of less than 1^{-x} seconds.

6. The method as claimed in claim 1, characterized in that the timebase establishes the defined time interval on the basis of GPS time.

7. The method as claimed in claim 1, characterized in that the protocol packets contain information about local time.

8. A system (A) having a number of units (2) and a time-synchronization apparatus, characterized in that the time-synchronization apparatus has a timebase unit (1), in that each of the units (2) is connected to the timebase unit (1) via a deterministic communications network (3), in that the timebase unit (1) has means for transmitting protocol packets (P) via the communications network (3) at a constant time interval (t), and in that each unit (2) has means for receiving these protocol packets (P) and means for at least approximately identical clocking of each unit (2) based on the constant time interval (t).

9. The system as claimed in claim 8, characterized in that the timebase has a GPS receiver.

10. The system as claimed in claim 8, characterized in that the communications network is a fieldbus system, a DOL network or a wire-free network.

11. The system as claimed in claim 8, characterized in that said system is a switchgear assembly or an automation system in the high- or medium-voltage range.
